(19) United States
(12) Patent Application Publication
(10) Pub. No.: US 2004/0063075 A1
(43) Pub. Date: Apr. 1, 2004

(54) Applicator and method for applying a sealing agent on smooth dental surface, in particular on interproximal surfaces

(76) Inventor: Naim Karazivan, Montreal (CA)

Correspondence Address: GOUDREAU GAGE DUBUC, 800 PLACE VICTORIA, SUITE 3400, MONTREAL, QUEBEC, H4Z 1E9, CA

(21) Appl. No.: 10/296,246

(22) PCT Filed: Jun. 11, 2001
(86) PCT No.: PCT/CA01/00824

(30) Foreign Application Priority Data
Jun. 9, 2000 (CA) 2311278

(51) Int. Cl. A61C 5/04

(52) U.S. Cl. 433/217.1; 433/80

(57) ABSTRACT

The invention concerns a device for applying a sealant (S) on an interproximal surface of a tooth (DT) comprising a closed surface (SF), positioning means (AL) for positioning the closed surface (SF) against an interproximal surface of the tooth (DT) to be treated, a sealing agent (AS) designed to be generally positioned between the closed surface (SF) and the interproximal surface and to adhere to the interproximal surface, and maintaining means (F, PMT2, C, EO) for maintaining the closed surface (SF) in position against the interproximal surface while the sealing agent (AS) is cured. The sealing agent (AS), when cured, constitutes at least part of the sealant (S) applied on the interproximal surface. The closed surface (SF) is flexible and designed to match at its periphery the interproximal surface so that the sealing agent (AS), when cured, substantially merges without interruption with the general surface of the tooth (DT), the general surface comprising the interproximal surface. The closed surface (SF) is designed to define, when pressed against the interproximal surface, a cavity (FC) designed to receive at least the sealing agent (AS).

### FIELD OF THE INVENTION

This invention concerns the application of sealing agents on smooth dental surfaces and, more particularly, on interproximal dental surfaces.

### BACKGROUND ART

It is known that sealing agents applied to teeth prevent and stop the tooth decay process. For instance, with a brush or a dropper, one can apply a layer of sealing agent on the occlusal surfaces that are easily accessed, and in a similar way, if desired, on the buccal and lingual dental surfaces. The sealing agents may hence take shape as a plastic film.

Sealing methods for the occlusal, having the object of stopping or preventing the occlusal caries CARO (see FIG. 1), are not efficient for applications where access is difficult, such as on the interproximal surfaces.

Also, dental floss is sometimes used for applying some nonrigid protective products (e.g., wax, hydrophilic or hydrophobic malleable film, etc.).

There is therefore a need for a product and a method that would allow the application of a durable protective covering in a biocompatible form on the surfaces said to be smooth and more particularly on the interproximal surfaces. A great portion of dental caries is located between the interproximal surfaces near the point of contact between two adjacent teeth, a protection of this region is thus desired to prevent or stop the process of the interproximal caries CARI.

In the article “Plastic Sealing of Proximal Surfaces of Teeth, A New Technique” [Journal of Baltimore College of Dental Surgeons, J. M. de Davila, R. F. Sisca, N. Tinanoff, D. V. Provenza, Jul. 30, 1975(1), pp. 40-47)], there is question of a sealant applicator destined for the sealing of interproximal surfaces. This applicator comprises a flat polyurethane strip including in its center a piece of absorbent tissue with a thickness of 250 microns and, on the sides of this piece of tissue, two lateral portions having a thickness of 60 microns. The described technique is as follows: An etching agent is at first applied on the teeth using the absorbing tissue, then another applicator is used to apply the auto-polymerizable sealant via its own absorbent tissue. This sealant still not polymerized is then covered during polymerization, by one of the lateral polyurethane portions of the applicator.

### SUMMARY OF THE INVENTION

It is an object of the present invention to provide an applicator allowing the application, on a smooth dental surface of a tooth, of a sealant of biocompatible morphology, as well as a method of applying this sealant. The treated dental surface on which this sealant is applied can have tooth decay (caries) or can be healthy. Particularly, the smooth dental surface is an interproximal surface.

According to the present invention, an device for applying, on a smooth dental surface, a sealant of biocompatible morphology is provided. This device comprises principally a closed surface as well as means for positioning said closed surface against a dental surface to be treated, means for maintaining said closed surface in position against the dental surface, and a sealing agent adapted to adhere to the dental surface.

Also, according to the present invention, there is provided a method for applying a sealing agent on a dental surface said to be smooth, comprising isolating dental surface to be treated and applying a sealant of biocompatible form on the latter.

According to the present invention, there is provided a device for applying a sealant on an interproximal surface of a tooth, comprising a closed surface, positioning means for positioning said closed surface against an interproximal surface to be treated of a tooth, a sealing agent adapted to be positioned between said closed surface and the interproximal surface and to adhere to the interproximal surface, and means for maintaining said closed surface in position against the interproximal surface during the curing of the sealing agent, the sealing agent when cured constituting at least part of the sealant applied to the interproximal surface.

Also, according to the present invention, there is provided a device for applying a sealant on an interproximal surface of a tooth, comprising a closed surface, positioning means to position said closed surface against an interproximal surface to be treated of a tooth, said closed surface being adapted to allow a sealing agent to be received generally between said closed surface and the interproximal surface, and maintaining means to maintain said closed surface in position against the interproximal surface during curing of the sealing agent, the sealing agent when cured adhering to the interproximal surface and constituting at least part of said sealant applied to the interproximal surface.

### BRIEF DESCRIPTION OF THE DRAWINGS

Having thus generally described the nature of the invention, a preferred embodiment of the present invention will now be described with reference to the annexed drawings:

FIG. 1 is an interproximal view of a tooth and of a positioning of anatomical elements.

FIG. 2 is a perspective view of teeth in contact with a regular reconstruction strip passing through these teeth, cross-section lines being also illustrated as reference.

FIG. 2A is a cross-section along the horizontal cross-section plan A of FIG. 2.

FIG. 2B is a cross-section along the vertical cross-section plan B of FIG. 2.

FIG. 2C is a cross-section similar to FIG. 2A, but showing the teeth separately and showing the nonanatomical contour of the sealant.

FIG. 2D is a cross-section similar to FIG. 2B, but showing the teeth separately and showing the nonanatomical contour of the applied sealant.

FIG. 3A is a cross-section along cross-section plan A of FIG. 2, showing the teeth separately, and is similar to FIG. 2C except that it illustrates a sealant applying device according to the present invention rather than the regular strip.

FIG. 3B is a cross-section along cross-section plan B of FIG. 2, showing the teeth separately, and is similar to FIG. 2D except that it illustrates a sealant applying device according to the present invention rather than the regular strip.

FIGS. 4A, 4B, 4C and 4D are schematic cross-sections similar to FIG. 3B and showing, according to the present invention, examples of sealant application on a tooth.

FIG. 5 is a global perspective view of the preferred embodiment of the sealant applying device of the present invention.

FIG. 6 is a global perspective view of a variant of the sealant applying device of the present invention.

FIG. 6A is an interproximal view of the variant of FIG. 6, positioned on a tooth.

FIG. 6B is a buccal view of the variant of FIG. 6, positioned on a tooth (a premolar that is the same as in FIG. 6A).

FIG. 7A is a cross-section along cross-section plan A of FIG. 2, showing two teeth separately and the sealant applying device of the present invention, the two teeth to be treated.

FIG. 7B is a cross-section along cross-section plan B of FIG. 2, showing two teeth separately and the sealant applying device of the present invention, the two teeth to be treated.

FIG. 8 is a global perspective view of two teeth in contact with a tartar removal scraper.

FIG. 9 is a global perspective view of the two teeth of FIG. 8, but during the use of the sealant applying device of the present invention.

FIG. 10 is a global perspective view of a variant of the sealant applying device of the present invention.

FIG. 11 is a global perspective view of another variant of the sealant applying device of the present invention.

FIG. 12 is a global perspective view of another variant of the sealant applying device of the present invention.

FIG. 13 is a global perspective view of another variant of the sealant applying device of the present invention.

FIG. 14 is a global perspective view of another variant of the sealant applying device of the present invention.

FIG. 15 is a global perspective view of another variant of the sealant applying device of the present invention.

### DEFINITIONS

Treated tooth DT: Tooth on which a sealant S is applied.

Adjacent tooth DA: Tooth adjacent to the treated tooth DT.

Contact surface CO: Point or surface of contact between two adjacent teeth.

Regular strip BR: Strip used as support matrix during dental reconstruction.

Dental enamel EM: Natural enamel found on the tooth.

Dentine DE.

Pulp chamber P.

Gingiva G.

Treated surface ST: Region of the smooth surface more vulnerable to tooth decay and that it is desired to protect by the sealant S applied by the present invention.

Occlusal caries CARO: Caries that is found totally or partly on the occlusal surface of the tooth.

Interproximal caries CARI: Caries that is found totally or partly on the interproximal surface of the tooth.

Root caries CARG: Caries that is found totally or partly on the surface of the root of the tooth.

Smooth dental surface: May be a mesial, distal, buccal or lingual surface of the tooth; this surface may have been restored or may, totally or partly, be a pulp surface.

Contaminants: Crevicular fluids, saliva, blood, dental plaque, tartar, oxygen or any other product present in the treated region impeding the adequate application of the sealant on the smooth surface; these contaminants can impede the polymerization and/or the adhesion and/or the application of the sealing agent.

Sealing agent AS: Includes, without restricting, any dental adhesive, dental cement, dental sealant, BIS-GMA-type resin, other materials usually for restoration, other cementing materials or other types of materials that can constitute a covering. These materials can be charged (e.g., microparticles), or uncharged. These materials may or may not contain one or more beneficial substances (e.g., fluor). These materials may or may not be polymerized to light, to ultraviolet or be autopolymerizable. The sealing agent AS must be able to adhere to a dental surface for a prolonged period (a plurality of months).

Protector film FP: This film consists of a cohesive product part of the sealant S and aimed at improving the efficiency of the sealant S. This film is inserted into the volume of the surface-cavity before or during the application procedure of the sealant S. This film can consist of a single piece or many fragments of product. This film may consist of a polymerized sealing agent, of a metal film (e.g., gold, metal alloy, titanium) or of any other biocompatible protective substance having a protective effect.

Conditioning agent AC: The conditioning agent AC includes, amongst others, an acid solution, such as phosphoric, citric or maleic acid, autoetching primers, conditioning primers that can be applied on the enamel, the dentine or the cement of the tooth for a given period of time to prepare the surface prior to the use of the sealing agent AS. This agent may, or may not, be removed by rinsing (e.g., with water) or be neutralized by a substance compatible with the sealing agent AS (e.g., neutralizing base or other neutralizer) prior to the application of this sealing agent. The conditioning agent AC may also be a solid or a liquid that facilitates the insertion of the sealing agent AS by being inserted prior to or simultaneously with the sealing agent (e.g., absorbing powder, absorbent spongy substance, alcohol, acetone, etc.).

Sealant S: Cohesive product left in place on the dental surface after the application procedure and resulting from this application. It may comprise one or many of the following elements or components of these elements: Sealing agent AS, protective agent, conditioning agent AC, protector film, closed surface SF (see description below), or other.

Nota Bene: The favourable characteristics of a sealing agent AS may be: fast polymerization time, strong adhesion to the enamel and hardness in thin layer. It is preferable that the sealing agent AS contain fluor or other agents favourable to the tooth and/or periodontinum. Complete polymerization in thin layer and low sensitivity to contamination (e.g., oxygen, humidity, etc.). Also, the sealing agent AS may be of a colour easily spottable by a clinician.

Closed Surface SF

In this section, the main part of the invention will be described, and different variants thereof will also be explained.

The closed surface SF consists of one or many materials that form a three-dimensional shape, such as a mold, capable of molding (without necessarily touching) the surface of the tooth ST that it is desired to treat while leaving one or many cavities to become created between the dental surface ST and this closed surface SF.

The surfaces of the closed surface SF that face the surfaces of the treated tooth are qualified as internal.

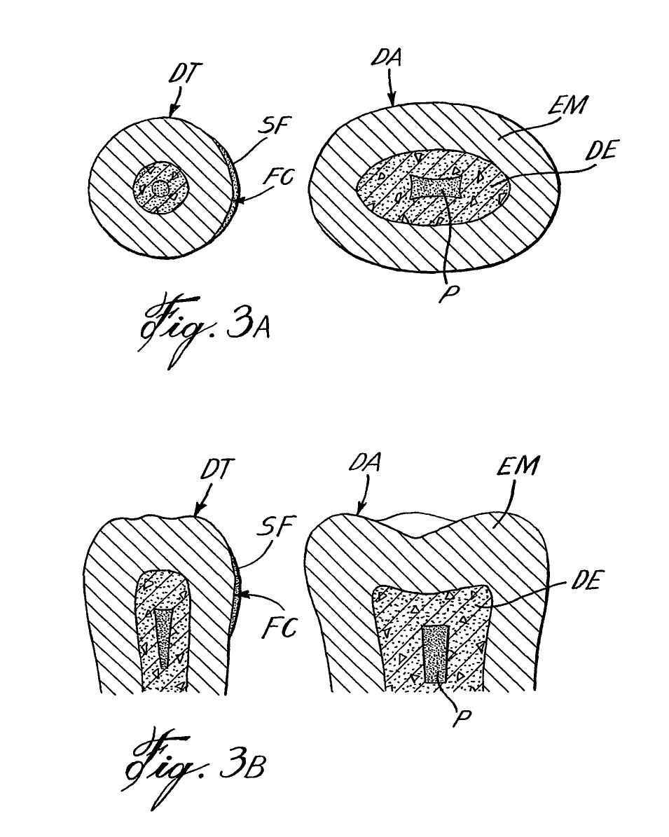

The volume of the cavity or the whole of the cavities at polymerization of the sealing agent AS will be called: Cavity sheet FC. This cavity sheet FC will act as a mold (bound by the treated surface ST and the closed surface SF) in a biocompatible form for the sealing agent AS. The cavity sheet FC has a very low average thickness, ideally averaging around 15 microns, but being variable in average between 1 and 150 microns. In FIGS. 3A and 3B, we find a schematic cross-section of the closed surface SF and of the cavity sheet FC on the treated tooth DT.

The closed surface SF is shaped such that, when it is adequately positioned against the surface of the tooth to be treated ST, the peripheral portions of its internal surface are on average closer or as close to the dental surface as the other portions of the internal surface.

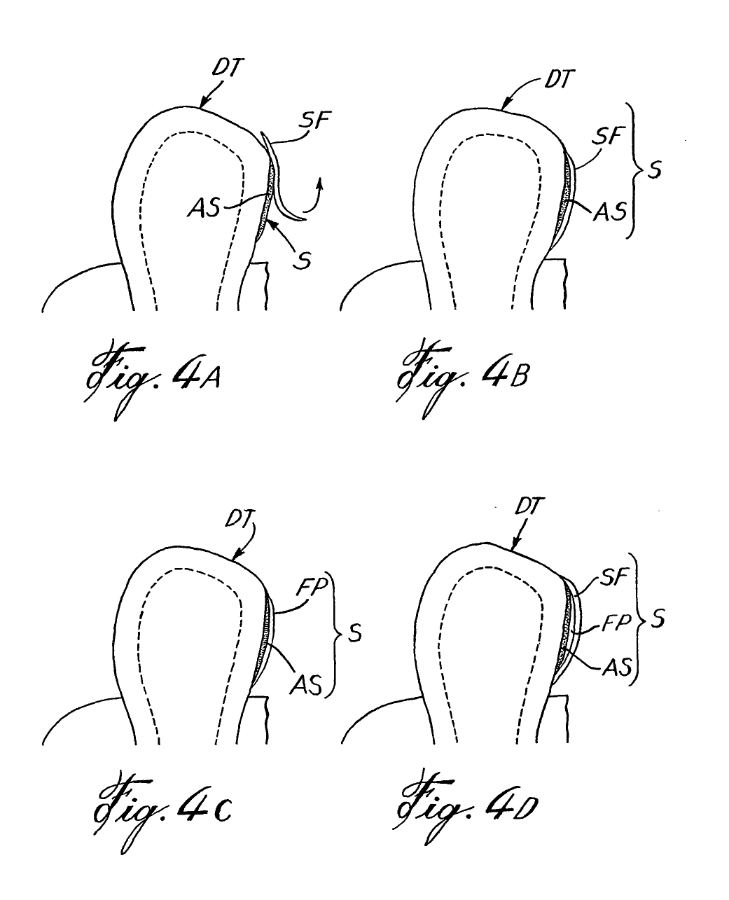

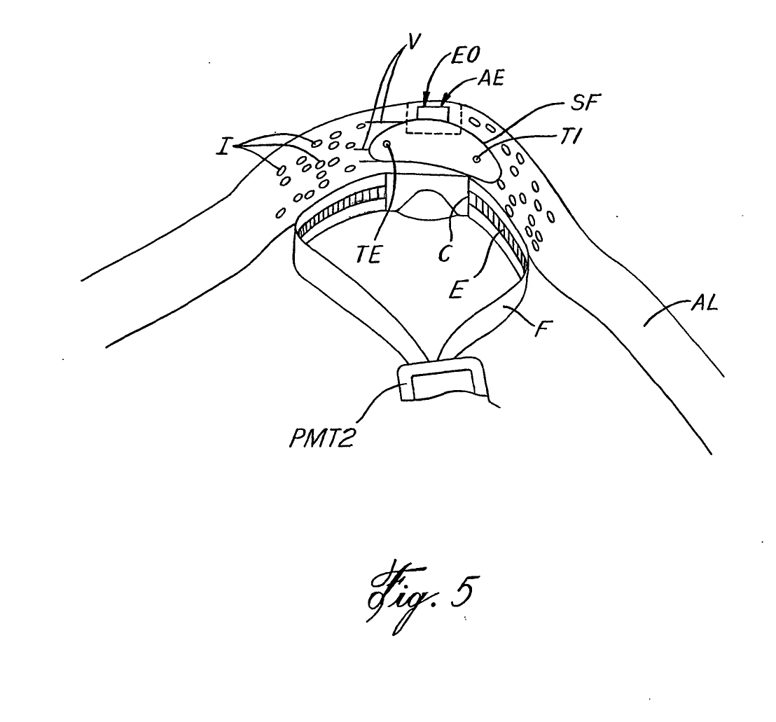

The sealant S (FIGS. 4A to 4D) which results from the molding with the cavity sheet FC will have a shape that will be in harmony with the biological shape of the dental surface that it covers and protects. The sealant S will thus be a thin layer of a few microns of thickness that will be clinically acceptable according to current clinical evaluation criteria and consequently will not represent an important change from the original tooth shape, and will not have important gaps.

The morphology of smooth dental surfaces varying strongly inter and intra patients, a closed surface SF conceived specially to adapt to the dental surface ST that must be treated is greatly desirable. This is possible by using a malleable (e.g., Mylar® film by Dupont of about 25 microns of thickness) or elastic material. It is possible, in creating this closed surface SF, that the sealing agent AS or the protector film or the other adjuvants are present between the tooth and the internal surface of the closed surface SF.

The closed surface SF is thus a 3D structure, which has a defined outline and which molds the dental surface. The periphery of this structure adapts very closely to the dental surface, while leaving a cavity, referred to as cavity sheet FC, which serves as a mold for the sealing agent AS.

There exist many variants to this closed surface SF, and the characteristics of these variants are described below.

Adapted Surface

It is possible to provide a closed surface SF that adapts adequately to the whole or to a portion of the smooth surfaces. In this case, it is possible to proceed by averaging the surfaces that must be included in the whole as well as by performing a three-dimensional proportional average of the surfaces, then an adjoining surface is chosen and the closed surface SF is conceived therein. Alternatively, it is possible to proceed by “trial and error” to develop a closed surface SF that suits the greatest number of smooth surfaces in the selected group.

Adaptable Surface

It is also possible to make a base closed surface SF in an adaptable material that the operator can adjust to the treated dental surface DT, e.g., Mylar®, stainless steel, gold, etc.

Nonadhering or Adhering Closed Surface SF

The closed surface SF may be made of a material that does not adhere to the sealing agent AS if it is desired that the sealant S be capable of detaching from the closed surface SF (FIG. 4A). However, it could be interesting—for example, to obtain a better surface finish, to obtain a more resistant covering or for other reasons—to create a closed surface SF that will adhere totally or in part to the sealing agent AS and that will thus be an integral part of the sealant S (FIG. 4B).

Textured Closed Surface SF

It is also possible that it is advantageous to have the internal surface of the closed surface SF micro or macrotextured, thereby forming a cavity sheet FC defined by many cavities or defining a textured nonsmooth surface finish. This can be done to increase the ease of adaptation on different types of smooth surfaces or to favour the polymerization of given sealing agents by lowering the surface tension.

Closed Surface SF with a Preapplied Film

It is also possible to preapply a protector film FP on the surface of the closed surface SF occupying totally or in part the volume of the cavity sheet FC. The protector film FP is a flexible protector film that increases the surface protection by covering the sealing agent and/or the surface of the tooth in the regions where there is a lack or absence of curing of the sealing agent AS during or after the application procedure. The protector film FP can be applied before or after the treatment, during the production of the closed surface SF, or by the operator. FIG. 4C shows the sealant S comprising the protector film FP and the sealing agent AS, while FIG. 4D illustrates a sealant S that includes the closed surface SF (in addition to the protector film FP and the sealing agent AS of FIG. 4C).

Closed Surface SF with Preapplication of a Component of a Sealing Agent

It is also possible to preapply a component of the sealing agent AS on the closed surface SF before or after the treatment, during production or by the operator. This is aimed at controlling the polymerization zone.

Closed Surface SF with Preapplication of Conditioning Agent AC

It is also possible to preapply a conditioning agent AC that can be applied during or after the treatment, during the production or by the operator.

Closed Surface SF with Voids V

The closed surface SF may also comprise voids V (e.g., holes or slots), that can serve, amongst other things, to break the tensions in the closed surface SF that impede the intimate adaptation of this closed surface SF to the dental surface.

The few variants of the closed surface SF described above may be embodied in various materials or combination of materials, for example, plastic or celluloid (Mylar®, polyester, nylon . . . ), metals (stainless steel, gold alloys, NI—TI, titanium or other), auto or photopolymerizing materials (polysiloxane print materials, e.g., Reprosil®, alginate, resin or other), stretchable films (of the SaranWrap® type, rubber type, urethane, PTFE, or other), prepolymerized materials (of a polymerized sealing agent or of a protector film).

For the closed surface SF described previously to be used with ease and efficiency, various components can be added. The following paragraphs describe components that can be added individually or in combination with others to the closed surface SF.

Lateral Wings AL

To allow the manipulation and positioning of the closed surface SF, lateral wings AL can be added to the closed surface SF (see FIGS. 5, 6, 7A, 10 and 11). The wings AL may have many various shapes, going from a simple string (e.g., dental floss) to a strip. The wings AL may consist of a material or many materials similar to that constituting the closed surface SF.

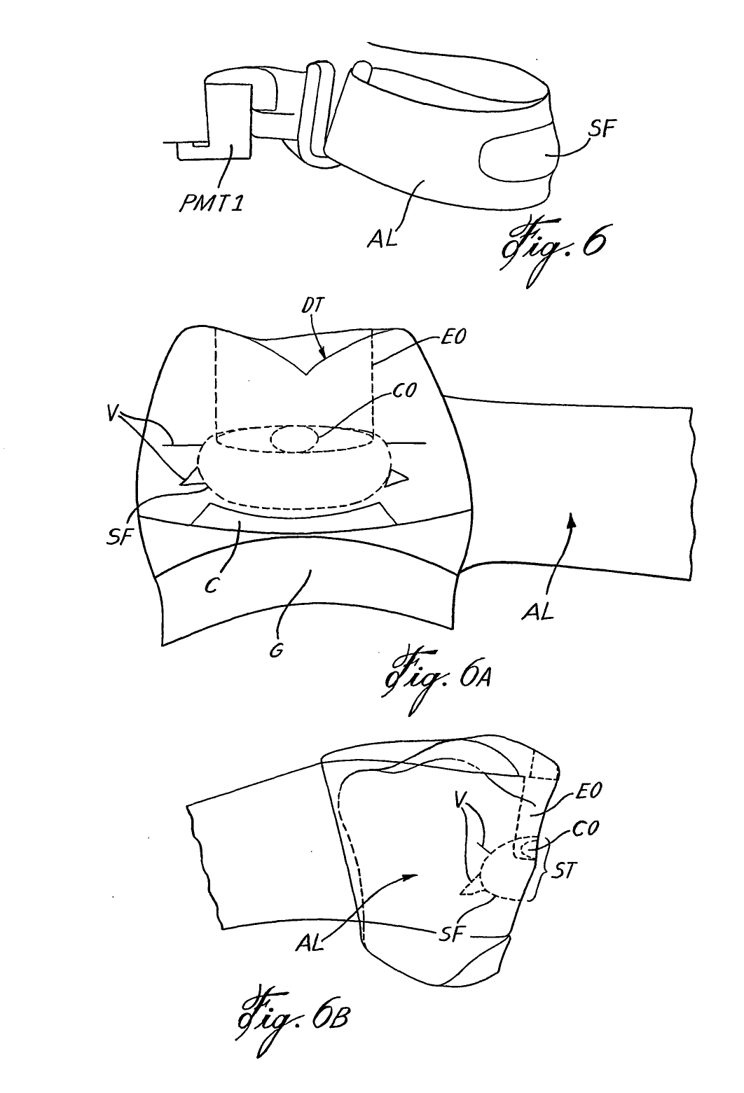

The wings AL can be tightened around the tooth DT by way of a “matrix-tightening”-type apparatus (e.g., tofflemire® matrix support PMT1; see FIGS. 6, 9 and 10).

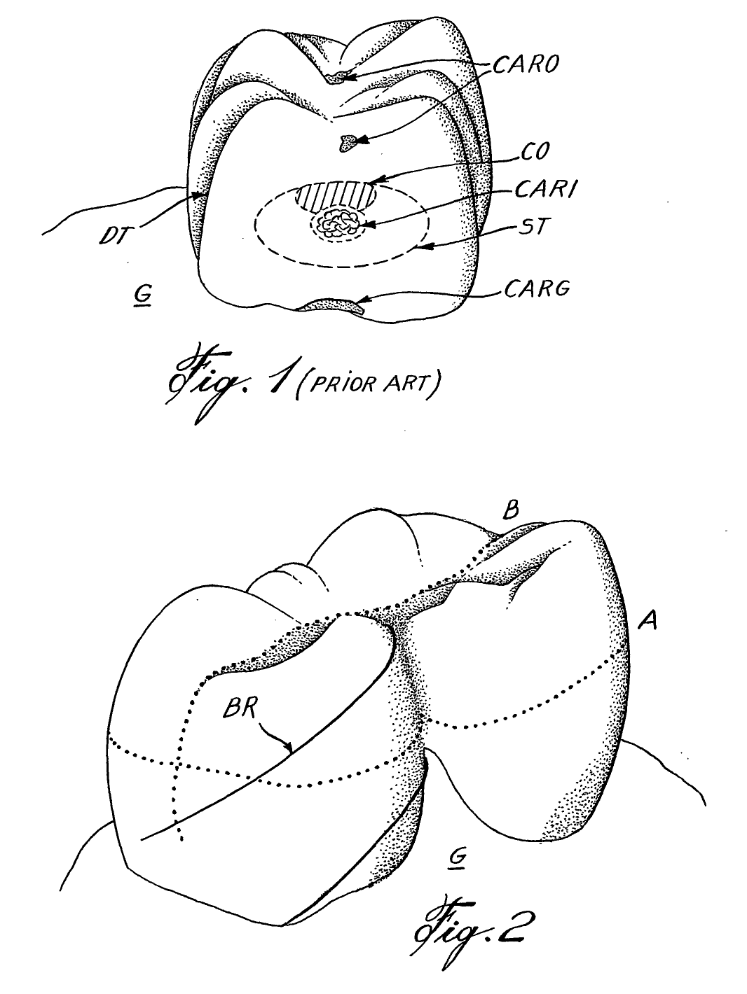

One of the wings AL can be passed through the contact surface CO (FIGS. 1, 6A and 6B) between the teeth, in order to entrain thereafter, by sliding, the closed surface SF on the region of the dental surface ST that must be sealed.

The wings AL may serve, when necessary, for the application of a force on the closed surface SF in order to keep the latter in intimate contact with the dental surface ST.

Anchoring System

It is often required to keep the closed surface immovable immobile once it has been positioned adequately for the whole duration of the polymerization of the sealing agent AS. It is consequently possible to use one or more anchoring systems that are bonded temporarily or permanently or juxtaposed to the closed surface SF before ordering the treatment. Here are some of the anchoring systems.

Anchor with Strip or String F

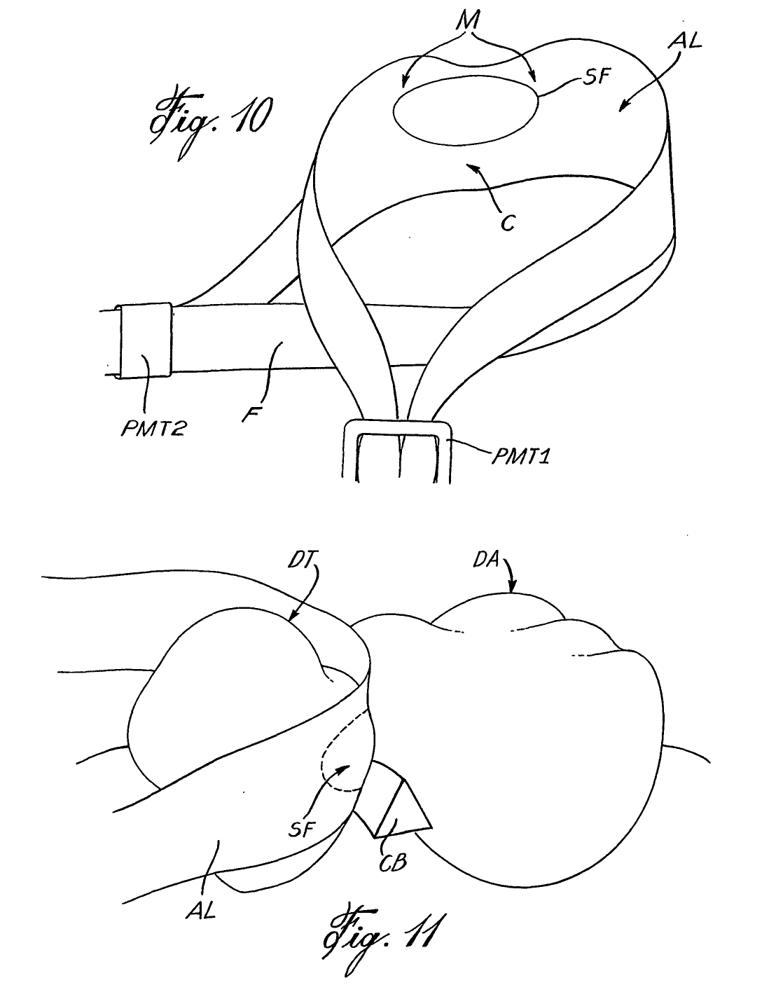

On the gingival side of the closed surface SF, an elongated element F (strip or string) is temporarily or permanently attached or juxtaposed to this side. This elongated element F (FIGS. 5 and 10) has for aim to firmly surround the treated tooth DT at the gingival level to hold the closed surface SF, and may accomplish a sealing that will isolate the closed surface SF from fluids coming from the gingival part. The elongated element F can be tightened around the tooth DT by way of a matrix support, e.g., tofflemire® matrix tightener PMT2 (see FIGS. 5 and 10), etc. The elongated element F may consist of or comprise a substance favouring the tightness (e.g., rubbery substance).

Anchor with Wooden Wedge CB

An element having the shape of an ordinary dental wooden wedge CB (FIG. 11) can be simply temporarily or permanently bonded or juxtaposed to the closed surface SF to keep the closed surface SF in position.

This system also allows obtainment of some isolation of the closed surface SF of the gingival portion. The wooden wedge CB is positioned in the proximal space in the usual way by wedging.

Anchor with Strip on Adjacent Tooth

Instead of surrounding the elongated element F described above around the treated tooth DT, it may be destined to surround one of the teeth DA adjacent to the treated tooth DT.

Anchor with Extension at Point of Contact

The closed surface SF may be held by an extension originating from the occlusal side of the closed surface SF that is destined to be wedged in the point or surface of contact CO. The pressure of the teeth on this structure allows keeping the whole of the closed surface SF in position.

This extension may consist of a thin film made of one or many materials (e.g., the same materials that can constitute the closed surface SF). The thickness of this extension may vary between 0.0005 and 0.010 inch.

This extension can also serve to space teeth in given situations.

Anchor with Handle

A handle MAN (FIG. 13) may be temporarily or permanently bonded or simply juxtaposed to the closed surface SF in order to position and hold the closed surface SF against the treated surface ST. The handle MAN may consist of one or many different types of materials. As the handle MAN, an instrument resembling a sampling tool or a seeker can be used, the end being sufficiently thin to be inserted into the interproximal space or in proximity thereof. The handle MAN may also comprise an internal tube for supplying the various products required for the application procedure (e.g., needle of a syringe, end of an air abrasion system, etc.).

Anchor with Curing System

A substance, capable of gaining an elastic memory or of becoming sufficiently rigid (e.g., printing paste, photopolymerizable or autopolymerizable resins, etc.), is disposed or forced around the closed surface SF to serve as both anchoring system and closed surface SF.

Anchoring with System of Arms

A system of arms that can be subjected to a “permanent deformation” (of the articulated-arm type), with, or without, an active force application system (e.g., spring) can be used to maintain the closed surface SF in position. This arm can be attached to a nearby structure of the treated surface ST (or other region of the same tooth, other teeth, gingiva G, etc.).

Anchor with Occlusal Extension

An occlusal extension EO (FIGS. 5, 6A, 6B and 12) can be added to the closed surface to allow the manual hold of the closed surface SF without using pressure from the contact surface CO. The operator then holds the extension EO by way of a given instrument (e.g., tweezers).

Anchor with an Inflatable Structure

A gingival bag (e.g., inflatable tube) can be attached to the closed surface SF and inserted into the interproximal space. Once it is inflated, the bag holds the closed surface SF in place by pressure. This bag can also serve as an isolation system.

The components described up to now allow manipulation and holding of the closed surface SF in place. Additional components that follow are related to other important aspects in realizing an adequate application, such as the isolation.

Isolation System

An isolation system allows prevention of the contamination of the volume of the cavity sheet FC, at least during the critical phases of application (e.g., polymerization of the sealing agent, etc.). This system allows principally prevention of contamination from the gingival. This system can be temporarily or permanently bonded or juxtaposed, before or during treatment, to the closed surface SF.

It is sometimes possible that another element of the system of the present invention performs the isolation without the requirement for an additional dedicated isolation system.

One or many isolation systems can be used to obtain a suitable isolation. Here are examples.

Isolation with Physical Element

A physical barrier can be used to create this isolation, for instance, a sealing joint E (FIG. 5) can be incorporated into the anchoring system (e.g., to the elongated element F) or may consist of an additional component per se. For example, an elastic or spongy membrane can cover the external surface of the closed surface SF and extend past the latter in periphery, thereby creating a sealing joint on the totality of the periphery.

Isolation with Active System

An active air- or other gas-injection active system can be coupled to a hole defined in the closed surface SF or to a periphery thereof in order to inject gas under pressure. This is aimed at actively repelling the contaminating agents.

Also, it is possible to use an active suction system (e.g., suction from the dental unit), of configuration and installation similar to the system described above by air injection, but operating by suction rather than by injection.

Inhibiting Agent

In order to control the application of sealant S in an undesired region, it is useful to place an inhibiting agent I (FIG. 5), in a physical shape or substance, that will inhibit the polymerization of the sealing agent AS. This has the advantage of limiting the excess and softening the outline of the applied sealant S. For example, on the internal faces of the applying device of the invention and in periphery to the closed surface SF, an inhibitor (e.g., water, talc powder, urethane, oil, oxygen, etc.) is placed before or during treatment, during production or by the operator. The inhibiting agent I can also be provided in the form of a texture or perforations incompatible with the polymerization of the sealing agent used.

Injection System

Considering that the described procedure includes the application of liquid and gaseous products, a system of canals can be incorporated into the application system of the invention in order to facilitate the application of various products required during the application procedure. Here are given examples.

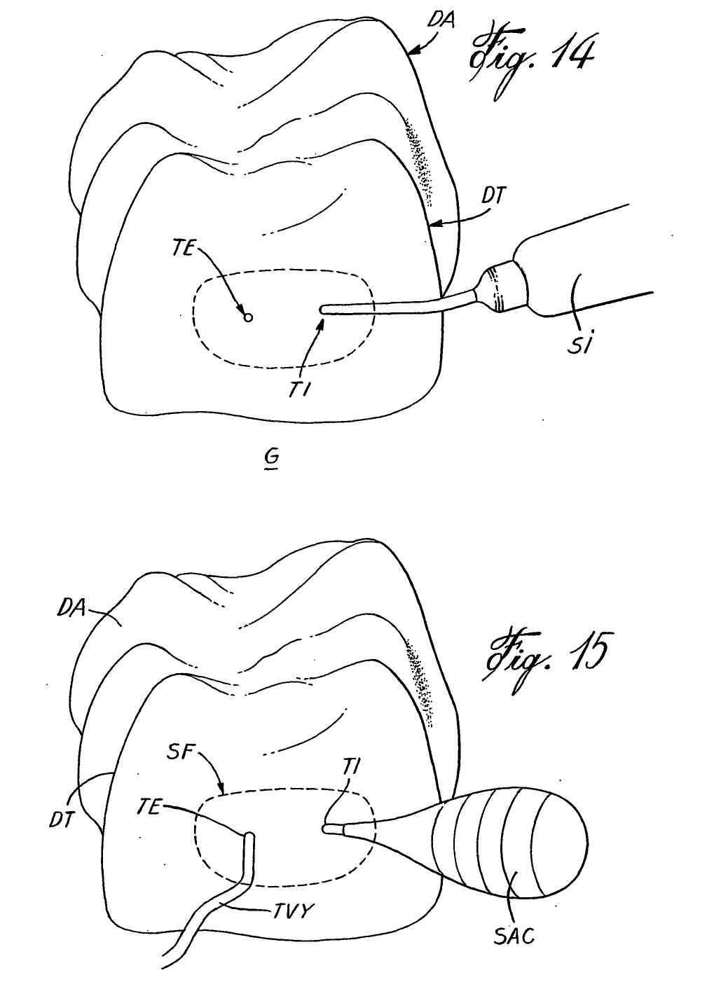

Apertures TI (FIGS. 5, 14 and 15) defined through the closed surface SF or through the region in periphery to the closed surface SF may constitute an entrance for the various products used (e.g., water, acid, air, conditioning agent AC, sealing agent AS, abrasive agent, etc.) during the application procedure. It is possible to then inject the various products through the apertures TI by way of a syringe SI (FIG. 14).

Alternatively, one or many pipes TUY (FIG. 15) can be coupled to the apertures TI, as the pipes TUY will ease access to the aperture TI, or to the apertures TI/TE (e.g., for access to the occlusal). These steps may even be performed from the exterior of the mouth; the operator would hence have his hands on the pipe or pipes TUY and would only need to inject the products being used in the corresponding pipe or pipes TUY. Pipes TUY could thus connect the closed surface SF to the hands of the clinician; the latter could hence inject the required products for the application from an exterior of the mouth.

Also, it is possible to use one or more capsule(s) SAC (FIG. 15) prefilled with the products used during application and connected to the pipes TUY described above. By pressing on these capsules SAC, the desired products would be introduced in the volume of the cavity sheet FC.

Evacuation System

In order to ease the displacement of the products being used (e.g., conditioning agent AC, water, sealing agent AS, etc.), evacuation holes TE (FIGS. 5, 14 and 15) can be included through the closed surface SF or through its periphery.

Optical Fibers

Optical fibers can be permanently or temporarily bonded or juxtaposed to the sealant applying device in order to provide the electromagnetic waves required for the polymerization of the sealing agent AS, which polymerizes to light, to ultraviolet or to other ways traveling by optical fibers. These optical fibers can be positioned in order to control the polymerization of the sealing agent AS to obtain polymerization on the desired surface. The wave source is positioned to face the end opposed to one closed to the closed surface SF.

Adaptation System for Depressions

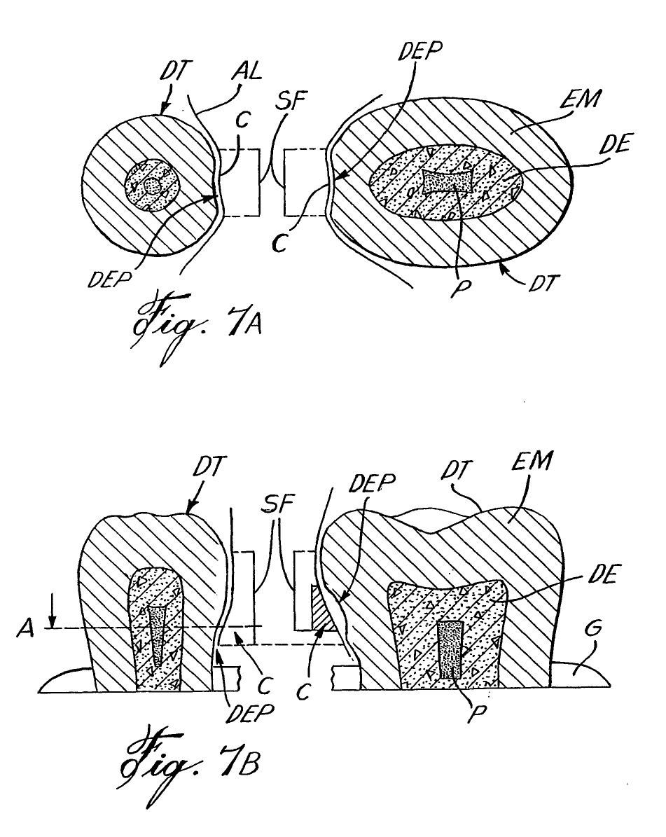

Some teeth comprise one or more depression(s) or concavity(ies) DEP (FIGS. 7A and 7B) on their smooth surfaces that can impede the adequate application of the sealant S (causing zones of excess or of shortage).

The closed surface SF may comprise a shape C (FIGS. 5, 6A, 7A, 7B and 10) that follows the configuration of such a concavity. If this is not the case, there can be provided, juxtaposed or bonded to the closed surface SF, and more particularly to the gingival and to the occlusal of this closed surface SF, a molding shape adapted to mold the depression(s) present on the dental surface ST. This molding shape C may consist of a flexible, spongy, compressible material (e.g., foam, rubber, etc., or the same material that constitutes the closed surface SF).

Positioning Guide

Visual and/or physical guides M (FIG. 10) are preferably included in periphery to the closed surface SF or elsewhere on the applying device, to help the operator in positioning the closed surface SF against the region of the smooth dental surface that is to be treated. The guides M are juxtaposed or bonded, temporarily or permanently, before or during the application procedure, on the closed surface SF.

These guides M can be printed, embossed or cut in, or on, the closed surface SF or on one or more of the neighbouring component(s).

A three-dimensional structure can be included in the invention to serve as visual and tactile guide M. This structure can lean on neighbouring structures of the treated surface ST and, therefore, help the operator in properly positioning the closed surface SF.

Absorbing Element

On the closed surface SF, it is possible to juxtapose or bond, temporarily or permanently, an absorbent that allows facilitation of the displacement or the retention of the fluid products used. This absorbent can increase the control of the product, the time of contact of the product with the dental surface, or facilitate the evacuation of fluids.

Spacing Agent

The spacing agent AE (FIG. 5) is a substance or instrument provided to space the teeth during the application procedure, when this is required.

This agent can be integrated into the applying device temporarily or permanently. For example, an occlusal extension EO of the closed surface SF can be incorporated so as to be insertable between the teeth at the level of the contact surface CO and thus space the teeth.

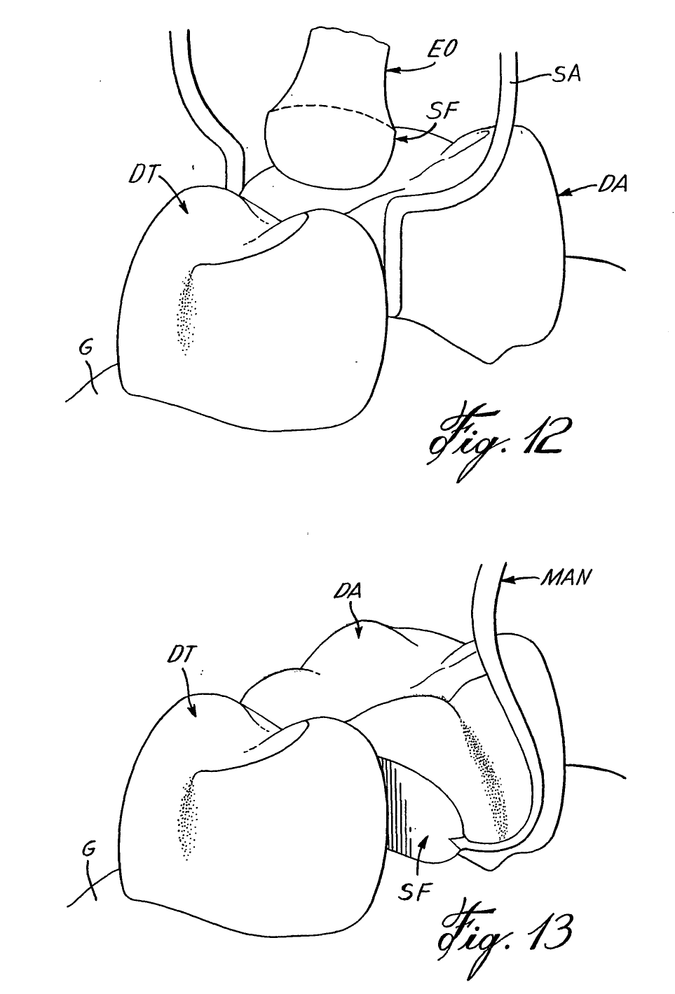

A spacing system SA for teeth can also be used in a totally independent fashion (FIG. 12), e.g., matrix, Palodent®-type spacer, wooden wedge CB, etc.

Agent for Indicating and Regulating the Pressure Exerted on the Closed Surface SF

It can be useful to apply a force of a given magnitude on the closed surface SF against the dental surface ST. Depending on the type of sealing AS used, there must be applied at times a force of a specific magnitude.

On the lateral wings AL and/or on the anchoring system and/or on any other structure of the application system, it is possible to include a system (e.g., elastics or springs) allowing to actively adjust the force applied on the closed surface SF.

It is also possible to include, on the lateral wings AL and/or on the anchoring system or on any other structure of the invention, a dynamometer, or an equivalent system, that can indicate to the operator the magnitude of the applied force, to enable him to hence adjust the applied force, if need be.

Humidity Indicator

It may be very useful to know the level of humidity in the cavity sheet FC at various steps of the application (e.g., before application of the various conditioning agents AC and sealing agents AS). Therefore, one or many humidity indicators (e.g., absorbing sheet with agent reacting to humidity, electronic indicator, absorbing sheet by itself, etc.) can be integrated into the application system temporarily or permanently, even being integratable at different moments before ordering the application procedure.

Tightness Indicator

To determine whether the closed surface SF is sufficiently well adapted against the surface ST of the tooth DT, there can be integrated various systems to the invention.

For instance, an air-pressure indicator can be coupled to the cavity sheet FC, by one or many apertures, passing through the closed surface SF or through its periphery. The injection under pressure of gas or of fluid (e.g., ambient air) in this cavity sheet FC by one or many apertures allows for a pressure indicator connected to the cavity sheet FC to indicate the pressure by calculating the pressure differential between the inlet and the outlet. An improper adaptation causes a leak that will create a drop in relative pressure. A proper adaptation will cause on the contrary a lesser leak that will create a high relative pressure.

Astringent Agent

In order to limit the risks of contamination that come at times from gingival bleeding, it may be useful to use an astringent agent.

An astringent agent (e.g., Hemodent®, cut-roll®, etc.) can be integrated into the applying device of the present invention in a structure that is gingival to the closed surface SF. For instance, the portions touching the gingiva G of the anchoring system and/or the lateral wings AL can be pre-impregnated therewith.

A retention substance of the absorbing type can be used for a better retention of the astringent agent.

Abrasive

To facilitate the finishing, an abrasive can be applied on one of the elements of the system.

Agent Beneficial to the Periodontinum

One or more component(s) of the sealant S can contain an agent beneficial to the periodontinum. The sealant S can be applied only for its periodontal effect (e.g., antimicrobial agent, osseous growth factor, anti-inflammatory agent, etc.). The sealant S could in these cases be applied more gingivally.

Other Notes

One or more application(s) can be made with the same system according to the invention, with the chosen materials and configuration.

It is possible to join many closed surfaces SF in the same applying device to perform a plurality of applications on many different dental surfaces ST.

The present invention may serve, other than for the application of the sealant S, to a controlled application on the dental surfaces and during an extended period (e.g., minutes or hours) of a protecting agent or of a cosmetic agent (e.g., whitening agent).

An additional strip passing through the cavity sheet FC can be added. This strip (e.g., having the shape of an interproximal dental sanding strip) is adapted for the preparation of the dental surface ST (e.g., cleaning abrasive, absorber comprising a conditioning agent AC, etc.) and can pass through the space between the internal surface of the closed surface SF and the dental surface ST.

Considering that the applying device of the present invention shows remarkable adaptation capacity on the smooth dental surfaces, it could be used for restoration techniques of smooth dental surfaces.

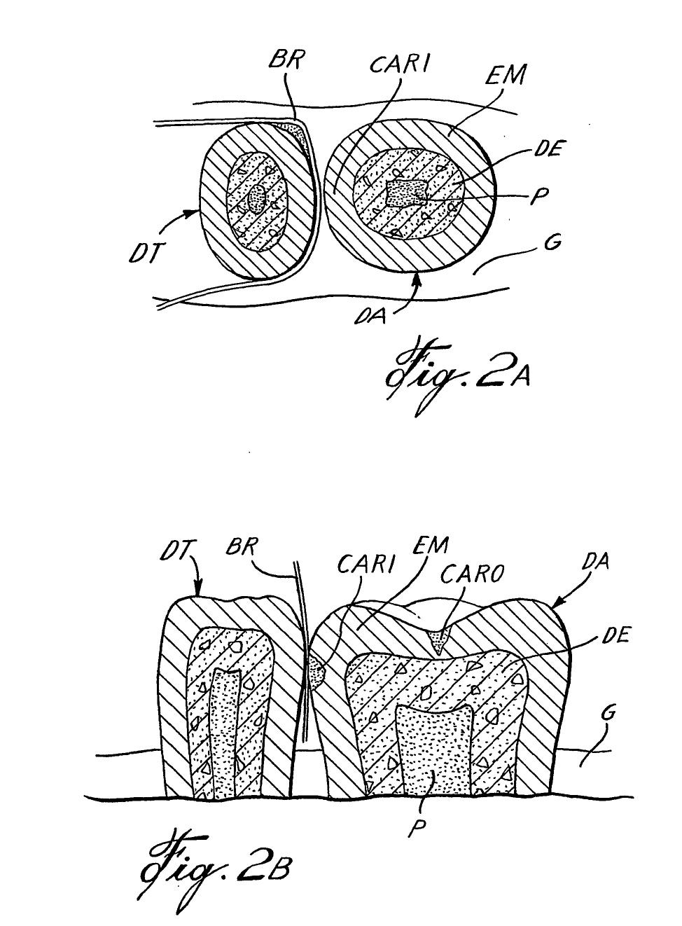

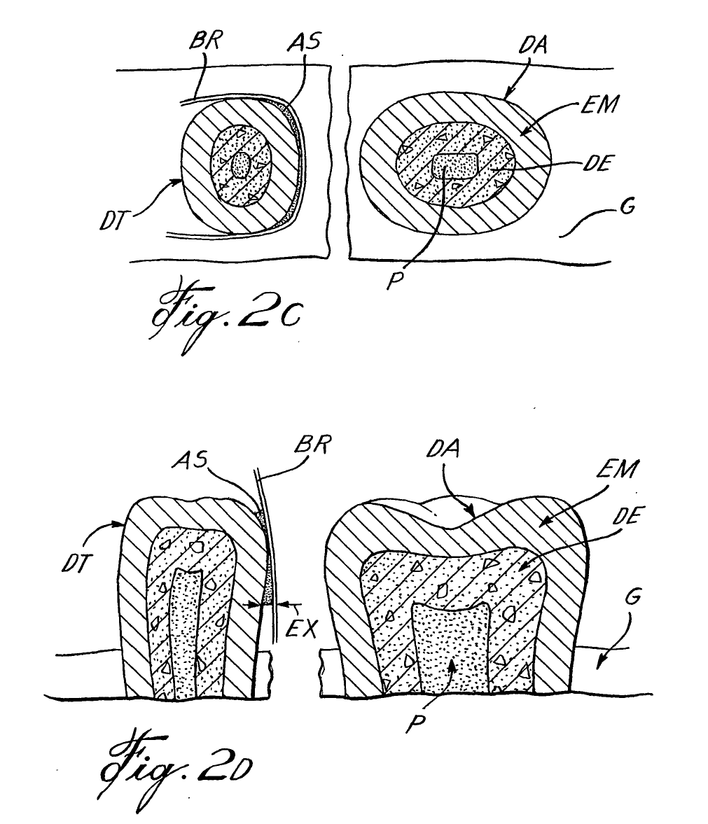

It must be noted that the use of current products, for instance, used in dental restoration, would not allow an application of a sealant of biocompatible morphology to the interproximal that respects the anatomy of the tooth to be effected. For example, if a regular reconstruction strip BR were used to apply a sealing agent AS (see the various FIG. 2), or even if it were attempted to use a brush, this would cause a lack of polymerization because of the contamination of the thin layer by oxygen or humidity, excesses EX (FIG. 2D) and a shape that does not respect the anatomy of the tooth (see FIGS. 2C and 2D) thereby possibly causing periodontal and functional problems during mastication.

On the other hand, the application of a sealant on the interproximal dental surface is possible with the present invention, whose characteristics have been described above and whose method of application follows hereinafter.

Application Method of Sealant to the Interproximal

Identification and Evaluation of the Surface to be Treated

One much initially verify that there is no contra-indication to treatment (e.g., presence of a very large caries, a typical morphology, medical contraindications, etc.).

Cleaning of the Surface to be Treated (FIG. 8)

With a scraper CUR and/or an abrasive sanding strip or with any other appropriate instrument, the operator cleans the surface to be treated ST as he usually does in a regular cleaning.

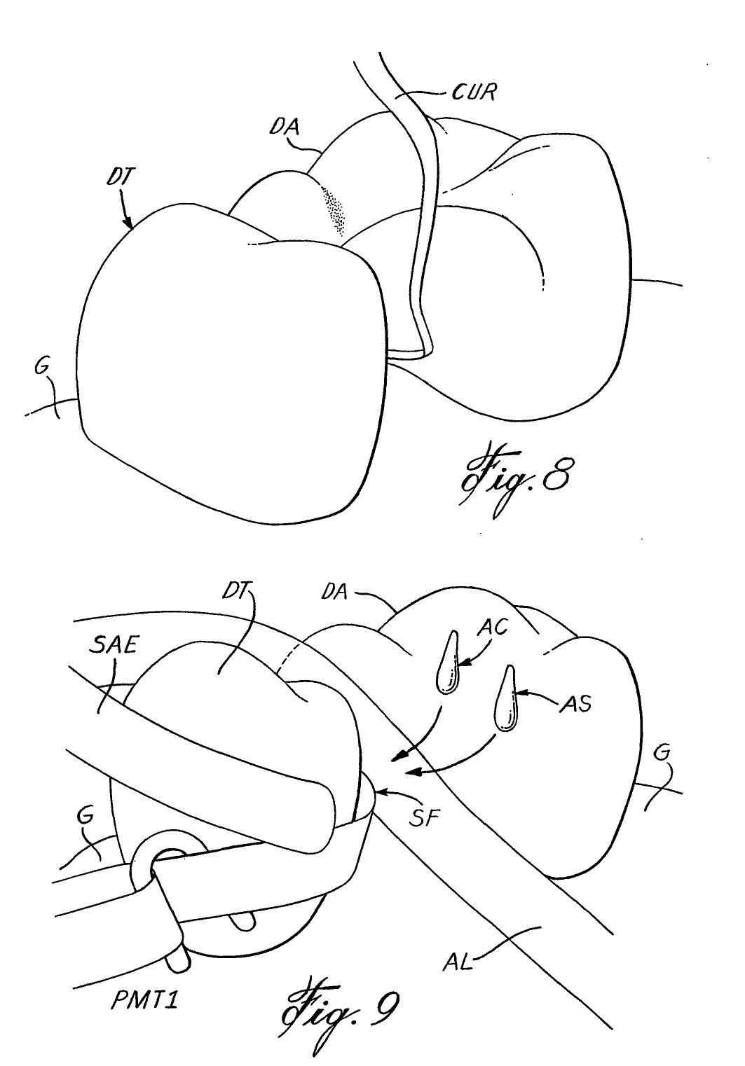

Setting Up of the Appling Device (FIG. 9)

The closed surface SF is set up by using, if required, the lateral wings AL. The insertion is performed by inserting one of the wings AL through the contact surface CO, then by sliding the closed surface SF into position.

Anchoring of the Closed Surface SF of the Applying Device

The elongated applying device and thus the closed surface SF are secured by tightening, with the help of the tofflemire® matrix support PMT2, around the tooth DT.

Spacing of the Teeth

In the case of the use of the preferred embodiment, a sufficient spacing is obtained by the spacing agent AE (which may take the form of the occlusal extension EO of the closed surface SF) during the insertion of the upper portion thereof above the closed surface SF between the teeth opposite the contact surfaces CO. If the spacing of the teeth is insufficient, the spacing system SA can also be used.

Preparation of the Dental Surface DT

The dental surface to be treated ST is then prepared, if required, with one or more of the following substances.

Etching of the Dental Surface to be Treated

Thirty-seven percent phosphoric acid (or other etching agent) is applied for a few seconds in the volume between the internal surface of the closed surface SF and the dental surface DT to be treated.

Rinsing

A rinsing of a few seconds is then effected thereafter. In the case of the use of an autoetching primer (i.e. not requiring rinsing), rinsing is not required.

Drying

Drying is performed, if necessary. Partial or total drying of the volume of the cavity sheet FC can be performed with a compressed gas (e.g., ambient air of the dental unit). A beam of compressed air with the water-air syringe SAE (FIG. 9) is then directed between the closed surface SF and the surface ST of the tooth DT. The lateral wings AL can help in directing the air jet. An absorbing section can be used to perform the drying totally or partly. In the case of a hydrophilic sealant S, a partial drying of the cavity sheet FC is desired.

Application of the Primer if Necessary

A primer is inserted into the volume between the internal surface of the closed surface SF and the dental surface ST to be treated for a few seconds, then dried by air for a few seconds.

Setting up of the Sealing Agent AS

A sealing agent AS (FIG. 9), e.g., Scotch Bond Multi Purpose Plus™ of 3M, is applied by passively leaving a drop of the sealing agent or by injection thereof under pressure at the interface closed surface SF and the surface ST of the tooth DT.

Then, if necessary, by slightly displacing in a back-and-forth motion the closed surface SF against the surface ST of the tooth DT, with the help of the lateral wings AL, one fills as much as possible the volume of the cavity sheet FC.

Application of a Force

If required, during polymerization, an average force in the direction of the surface ST of the tooth DT can be exerted on the closed surface SF because of, amongst others, the lateral wings AL. It is possible to use the matrix support PMT1 to tighten the lateral wings AL around the tooth DT.

Removal of the Applying Device

Once the polymerization is over, the applying device is removed, leaving the sealant S in position against the dental surface ST.

Removal of Excess and Finishing

A verification of the treated surface ST with the help of a dental probe is performed (e.g., periodontal probe, dental explorer, etc.). If excesses are detected, they are then removed with a scraper and/or a sanding strip. The surface ST may then be polished with the help of a polishing strip (e.g., moderate to fine abrasive strip).

Having generally described the whole of the procedure, there follow hereinbelow a few possible variants and/or characteristics of the procedure.

A Plurality of Strips for the Same Application

One or more devices for application can be used for the same application procedure.

Repeated Removal and Reinstallation of the Applying Device During the Procedure

For example, after etching, the applying device can be removed to ensure that there is no acid residue thereon.

Application on a Noninterproximal Smooth Surface

For a noninterproximal surface (e.g., buccal or lingual), the procedure remains the same with the exception of the fact that it is not as necessary to proceed with the spacing of the teeth.

Air-Abrasion System for the Cleaning of the Surface

Instead of cleaning the surface prior to the insertion of the device, it is possible to install the applying device, then use an abrasive jet with an air-abrasion system to clean the dental surface ST and start preparation. This allows to clean only the dental surface ST that it is desired to be treated by isolation thereof with the applying device. This can also be performed with a laser instrument (currently existing on the market) or with a drill.

Use of a Handle and of a Tube

In the case where the anchoring system is a handle MAN connected to the closed surface SF, the application method varies substantially. This variant of the invention allows the surfaces that are more easily attained to be sealed more readily. The operator can hold the handle MAN such that the closed surface SF is in contact with the tooth DT during the various steps of the procedure.

To convey the products used and the sealing agent AS, the operator can, in addition to all other methods and options described above, dip the closed surface SF into the various products used.

The nature of the handle MAN can vary during the procedure.

1. A device for applying a sealant on an interproximal surface of a tooth, comprising a closed surface, positioning means for positioning said closed surface against an interproximal surface to be treated of a tooth, a sealing agent adapted to be positioned generally between said closed surface and the interproximal surface and to adhere to the interproximal surface, and maintaining means for maintaining said closed surface in position against the interproximal surface during curing of the sealing agent, the sealing agent when cured constituting at least part of the sealant applied to the interproximal surface.

2. A device according to claim 1, wherein said closed surface is flexible and is adapted to mold in a periphery thereof the interproximal surface such that said sealing agent, when cured, substantially merges without interruption with a general surface of the tooth, the general surface comprising the interproximal surface.

3. A device according to claim 2, wherein said closed surface is adapted to define, when in position against the interproximal surface, a cavity, said cavity being adapted to receive at least said sealing agent.

4. A device according to claim 3, wherein said closed surface, when said sealing agent is cured against the interproximal surface and inside said cavity, is adapted to be removed from the sealing agent.

5. A device according to claim 4, wherein a protector film is included between said closed surface and said sealing agent, said protector film being adapted to cover said cured sealing agent and constituting with said cured sealing agent at least a part of the sealant.

6. A device according to claim 3, wherein at least part of said closed surface, when the sealing agent is cured against the interproximal surface and inside said cavity, is adapted to remain secured to the sealing agent and form with the cured sealing agent at least part of the sealant.

7. A device according to claim 6, wherein a protector film is included between said closed surface and said sealing agent, said protector film being adapted to cover the cured sealing agent, at least part of said closed surface, when the sealing agent has cured against the interproximal surface and inside said cavity, being adapted to remain secured against said protector film in order to form with the cured sealing agent and said protector film at least part of the sealant.

8. A device according to claim 1, wherein said positioning means comprise lateral elements extending from either side of said closed surface and being slidable in an interproximal space between two adjacent teeth.

9. A device according to claim 8, wherein said lateral elements are also included in said maintaining means used to maintain said closed surface in position against the interproximal surface during the curing of the sealing agent.

10. A device according to claim 9, wherein said maintaining means comprise a mold strap acting against said lateral elements in order to maintain said closed surface in position against the interproximal surface.

11. A device according to claim 1, wherein said maintaining means comprise an anchoring system to maintain temporarily or permanently the closed surface against the interproximal surface.

12. A device according to claim 11, wherein said anchoring system comprises, on a gingival side of said closed surface, an elongated element adapted to surround the treated tooth and isolate said closed surface from fluids coming from the gingival part.

13. A device according to claim 12, wherein said elongated element is adapted to be coupled to a mold strap adapted to tighten the elongated element around the treated tooth.

14. A device according to claim 13, wherein said elongated element comprises a tightness member.

15. A device according to claim 11, wherein said anchoring system comprises of an element being shaped as a wooden wedge adapted to maintain the closed surface in position.

16. A device according to claim 11, wherein said anchoring system comprises an extension projecting on an occlusal side of said closed surface and adapted to be fixed in the point or surface of contact of two adjacent teeth.

17. A device according to claim 16, wherein said extension consists of a thin film.

18. A device according to claim 16, wherein said extension has a thickness so as to be a spacing member between adjacent teeth.

19. A device according to claim 11, wherein said anchoring system comprises a handle adapted to be coupled to said closed surface in order to position and maintain said closed surface against the treated surface.

20. A device according to claim 19, wherein said handle includes a tip sufficiently thin to be inserted into the interproximal space between two adjacent teeth.

21. A device according to claim 19, wherein said handle comprises an internal tube for the supply of the various fluid products required for the application procedure of the sealant.

22. A device according to claim 11, wherein said anchoring system comprises a substance with an elastic memory or capable of becoming sufficiently rigid in order to also act, when installed around said closed surface, as closed surface.

23. A device according to claim 11, wherein said anchoring system comprises an arm system adapted to be subjected to a permanent deformation with, or without, an active force-applying system.

24. A device according to claim 23, wherein said arm system is loaded with a spring.

25. A device according to claim 11, wherein said anchoring system comprises an occlusal extension related to said closed surface in order to allow manual maintaining of said closed surface in maintaining said occlusal extension in position.

26. A device according to claim 11, wherein said anchoring system comprising a gingival bag adapted to be connected to said closed surface and inserted into the interproximal space, in order to said closed surface.

27. A device according to claim 2, wherein said closed surface is deformable in order to be capable of generally following the configuration of the interproximal surface.

28. A device according to claim 27, wherein said closed surface consists of a plastic material capable of plastic or elastic deformation.

29. A device according to claim 1, wherein said closed surface comprises a conditioning agent.

30. A device according to claim 1, wherein said closed surface comprises openings adapted to break tension in said closed surface that can impede the close adaptation of said closed surface on the interproximal surface.

31. A device according to claim 1, wherein a tightness member is included to cover the external surface of said closed surface and extend beyond same in periphery, thereby ensuring the tightness of the closed surface on a complete periphery thereof.

32. A device according to claim 3, wherein at least one aperture is defined through said closed surface and forms an entrance for various used products, e.g., water, acid, air, conditioning agent, sealing agent, abrasive agent, during the application procedure.

33. A device according to claim 32, wherein a syringe is used to inject said products through the aperture and into said cavity.

34. A device according to claim 32, wherein at least a tube is adapted to be coupled to said aperture.

35. A device according to claim 32, wherein at least one capsule prefilled with a product to be used during the application is connected to said aperture.

36. A device according to claim 3, wherein at least one evacuation aperture is defined through said closed surface and is an outlet for various products used during the application procedure, e.g., conditioning agent, water, sealing agent, in order to facilitate conveying of these products.

37. A device according to claim 1, wherein optical fibers are included in order to transmit electromagnetic waves required for the polymerization of the sealing agent.

38. A device according to claim 1, wherein, for teeth comprising at least one depression on interproximal surfaces thereof, said closed surface comprises a shape adapted to mold the configuration of the depression.

39. A device according to claim 38, wherein said shape consists of a flexible, spongy and compressible material.

40. A device according to claim 1, wherein visual and/or physical guides are included to help the operator in positioning said closed surface against the interproximal surface to be treated.

41. A device according to claim 40, wherein said guides are positioned in periphery of said closed surface.

42. A device according to claim 40, wherein said guides are printed, embossed or cut at the level of said closed surface or adjacent thereto.

43. A device according to claim 1, wherein said closed surface comprises an absorbent allowing to facilitate the conveying or the retention of the fluid products used.

44. A device according to claim 43, wherein said absorbent increases the control of the product, the time of contact of the product with the interproximal surface and/or facilitates the evacuation of the fluids.

45. A device according to claim 1, wherein a system of adjustment of the force exerted on said closed surface is included.

46. A device according to claim 1, wherein a system for measuring the force exerted on said closed surface is included.

47. A device according to claim 3, wherein a humidity indicator is included to indicate the degree of humidity in said cavity.

48. A device according to claim 3, wherein a tightness indicator is included to measure the tightness of said closed surface against the interproximal surface.

49. A device according to claim 48, wherein said tightness indicator comprises an air-pressure indicator coupled to said cavity.

50. A device according to claim 1, wherein an astringent agent is included in a structure gingival to said closed surface in order to limit the risks of contamination.

51. A device according to claim 1, wherein, in order to control the application of sealant in an undesired region, an inhibiting agent is used that inhibits the polymerization of the sealing agent.

52. A device according to claim 51, wherein said inhibiting agent is applied to the internal faces located exteriorly to said closed surface and in periphery of said closed surface.

53. A device according to claim 51, wherein said inhibiting agent comprises a texture or perforations incompatible with the polymerization of the sealing agent.

54. A device according to claim 1, wherein said closed surface is made of Mylar®.

55. A device according to claim 54, wherein said closed surface has a thickness between 0.0005 and 0.003 inch.

56. A device for applying a sealant on an interproximal surface of a tooth, comprising a closed surface, positioning means to position said closed surface against an interproximal surface to be treated of a tooth, said closed surface being adapted to allow a sealing agent to be received generally between said closed surface and the interproximal surface, and maintaining means to maintain said closed surface in position against the interproximal surface during the curing of the sealing agent, the sealing agent when cured adhering to the interproximal surface and forming at least part of the sealant applied to the interproximal surface.

57. A device according to claim 56, wherein said closed surface is adapted to mold in a periphery thereof the interproximal surface such that the sealing agent, when cured, follows generally without interruption the general surface of the tooth, the general surface comprising the interproximal surface.

58. A device according to claim 57, wherein said closed surface is adapted to define, when in position against the interproximal surface, a cavity, said cavity being adapted to receive at least the sealing agent.

59. A method for applying a sealing on an interproximal surface of a tooth, comprising the installation of an isolating element on the interproximal surface to be treated, the application of a sealing agent between the isolation element and the interproximal surface, and the maintaining of the isolation element against the interproximal surface during the curing of the sealing agent.

60. A method according to claim 59, wherein the isolation element comprises a closed surface adapted to mold in a periphery thereof the interproximal surface such that the sealing agent, when cured, merges substantially without interruption with the general surface of the tooth, the general surface comprising the interproximal surface.

61. A method according to claim 60, wherein said closed surface defines, when in position against the interproximal surface, a cavity, said cavity being adapted to receive at least said sealing agent.

62. A method according to claim 61, wherein said closed surface, when the sealing agent has cured against the interproximal surface and inside said cavity, is removed from the sealing agent.

63. A method according to claim 62, wherein a protector film is included between said closed surface and said sealing agent, said protector film covering the cured sealing agent and constituting with said cured sealing agent at least part of the sealant.

64. A method according to claim 60, wherein the positioning of the closed surface is effected by lateral elements projecting from either side of said closed surface and being slidable in the interproximal space between two adjacent teeth.

65. A method according to claim 63, wherein the maintaining of the closed surface is performed via said lateral elements.

66. A method according to claim 64, wherein the maintaining of the closed surface is performed by a mold strap acting on said lateral elements in order to maintain said closed surface in position against the interproximal surface.

67. A method according to claim 60, wherein said closed surface is deformable so as to substantially follow the configuration of the interproximal surface.

68. A method according to claim 67, wherein said closed surface is made of a plastic material capable of elastic or plastic deformation.

69. A method according to claim 60, wherein said closed surface comprises a conditioning agent.

70. A method according to claim 60, wherein a tightness member is positioned to cover the external surface of said closed surface and project past same in periphery, thereby ensuring the tightness of the closed surface on a complete periphery thereof.

71. A method according to claim 61, wherein at least one aperture is defined through said closed surface, various products, e.g., water, acid, air, conditioning agent, sealing agent, abrasive agent, being introduced into the cavity during the application procedure by said aperture.

72. A method according to claim 71, wherein a syringe is used to inject said products through the aperture and into said cavity.

73. A method according to claim 71, wherein at least one tube is coupled to said aperture.

74. A method according to claim 71, wherein at least one product is contained in a prefilled capsule connected to said aperture such that the product is transmitted to the cavity.

75. A method according to claim 61, wherein at least one product used during the application procedure, e.g., conditioning agent, water, sealing agent, is evacuated from the cavity by an evacuation aperture defined through said closed surface.

76. A method according to claim 60, wherein optical fibers are used in order to transmit electromagnetic waves required for the polymerization of the sealing agent.

77. A method according to claim 60, wherein, for teeth comprising at least one depression on interproximal surfaces thereof, said closed surface comprises a shape adapted to mold the configuration of the depression.

78. A method according to claim 77, wherein said shape consists of a flexible, spongy and compressible material.

79. A method according to claim 60, wherein visual and/or physical guides are included to help the operator in positioning said closed surface against the interproximal surface to be treated.

80. A method according to claim 60, wherein said closed surface comprises an absorbent allowing to facilitate the conveying or the retention of the fluid products used.

81. A method according to claim 80, wherein said absorbent increases the control of the product, the time of contact of the product with the interproximal surface and/or facilitates the evacuation of fluids.

82. A method according to claim 60, wherein the force exerted on said closed surface can be adjusted.

83. A method according to claim 60, wherein the force exerted on said closed surface is measured.

84. A method according to claim 61, wherein a humidity indicator is included to indicate the degree of humidity of in said cavity.

85. A method according to claim 61, wherein a tightness indicator is included to measure the tightness of said closed surface against the interproximal surface.

86. A method according to claim 60, wherein an astringent agent is included in a structure gingival to said closed surface in order to limit the risks of contamination.

87. A method according to claim 59, wherein, in order to control the application of sealant in a an undesired region, an inhibiting agent is included which inhibits the polymerization of the sealing agent.

88. A method according to claim 87, wherein said inhibiting agent is applied on the internal surfaces located exteriorly to said closed surface and in periphery of said closed surface.
